(19) United States
(12) Patent Application Publication
(10) Pub. No.: US 2025/0354659 A1
(43) Pub. Date: Nov. 20, 2025

(54) SYSTEM AND METHOD FOR STORING LIQUIDS HAVING LOW LATENT HEAT OF VAPORIZATION

(71) Applicant: Nuovo Pignone Tecnologie – S.r.l., Florence (IT)

(72) Inventors: Joseph Moate, Oklahoma City, OK (US); David Madden, Limerick City (IE); Vinh K. Do, Oklahoma City, OK (US); Jason Angolano, Oklahoma City, OK (US); Jose Adrian Chavez Velasco, Ciudad Guzman (MX); Maruthi N. Devarakonda, Houston, TX (US); Nazanin Rahimi, Austin, TX (US); Graham Benjamin Wenz, Richmond, CA (US)

(21) Appl. No.: 19/207,576

(22) Filed: May 14, 2025

Related U.S. Application Data
(60) Provisional application No. 63/647,350, filed on May 14, 2024.

(51) Int. Cl. F17C 7/04; F17C 11/00; F17C 13/02

(52) U.S. Cl. CPC F17C 7/04; F17C 11/00; F17C 13/025; F17C 2221/012; F17C 2223/0161; F17C 2225/0161; F17C 2227/04; F17C 2250/043; F17C 2265/032; F17C 2270/0581

(57) ABSTRACT

Disclosed herein is a storage system for storing low latent heat of vaporization gases comprises a primary storage tank for storing a liquid having a latent heat of vaporization of less than or equal to 1000 joules per gram, and a secondary storage tank comprising a porous sorbent for reversibly storing a boil-off gas released from the primary storage tank.

### CROSS REFERENCE TO RELATED APPLICATIONS

This application claims the benefit of an earlier filing date from U.S. Provisional Application Ser. No. 63/647,350 filed May 14, 2024, the entire disclosure of which is incorporated herein by reference.

### BACKGROUND

Hydrogen is widely recognized as a clean and efficient energy carrier, with growing applications across transportation, industrial, and aerospace sectors. Among various storage forms, liquid hydrogen (LH₂) offers an energy density per unit volume of greater than 5 megajoules per liter, making it particularly attractive for applications that use compact and lightweight fuel systems. Storing liquid hydrogen involves the use of advanced cryogenic tanks featuring multi-layer insulation and high-performance vacuum systems, owing to hydrogen's extremely low boiling point of approximately 20 Kelvin (−424 degrees Fahrenheit). However, one of the key challenges associated with liquid hydrogen storage is the phenomenon of boil-off—the gradual evaporation of hydrogen due to heat ingress, even within well-insulated cryogenic tanks. This evaporation leads to a continuous pressure increase within the storage vessel, necessitating either venting of the gaseous hydrogen to maintain safe operating conditions or implementation of complex and often inefficient recirculation systems.

Boil-off not only results in fuel loss and reduced system efficiency but also poses safety, environmental, and regulatory concerns, especially in confined or sensitive operational environments such as urban transport, aircraft cabins, and enclosed industrial facilities. The issue is further exacerbated in mobile applications (such as trucks, buses, agricultural equipment, construction machinery, mining vehicles, manned and unmanned aircraft) where frequent acceleration, vibration, and changing ambient conditions can intensify thermal loading and complicate pressure management.

Strategies to address hydrogen boil-off include venting to atmosphere, using pressure relief valves, or routing the vapor to auxiliary burners or fuel cell subsystems. However, these methods often lead to energy inefficiencies, added system complexity, or increased emissions. Accordingly, there is a critical need for improved systems and methods that can actively capture, utilize, or mitigate hydrogen boil-off in a safe, efficient, and application-flexible manner.

### SUMMARY

In an embodiment, disclosed herein is a storage system for storing low latent heat of vaporization gases comprises a primary storage tank for storing a liquid having a latent heat of vaporization of less than or equal to 1000 joules per gram, and a secondary storage tank comprising a porous sorbent for reversibly storing a boil-off gas released from the primary storage tank.

In yet another embodiment, disclosed herein is a method of storing low latent heat of vaporization gases comprises discharging a boil-off gas released from a primary storage tank to a secondary storage tank; wherein the primary storage tank is operative to store a liquid having a latent heat of vaporization of less than or equal to 1000 joules per gram; and wherein the secondary storage tank comprises a porous sorbent for reversibly storing the boil-off gas discharged from the primary storage tank.

### BRIEF DESCRIPTION OF THE DRAWINGS

The following descriptions should not be considered limiting in any way. With reference to the accompanying drawings, like elements are numbered alike:

FIG. 1 depicts a system for storing a liquid having low latent heat of vaporization; and

FIG. 2 depicts the hydrogen adsorption of a porous sorbent 120 in the secondary storage tank 104. The y-axis has two scales: Total H₂ Adsorbed in g/L (left y-axis) and Total H₂ Adsorbed in wt % (right y-axis).

### DETAILED DESCRIPTION

A detailed description of one or more embodiments of the disclosed system and method are presented herein by way of exemplification and not limitation with reference to the Figures.

In one aspect, disclosed herein is a storage system that combines a primary storage tank and a secondary storage tank for storing a liquid having low latent heat of vaporization below 1000 joules per gram (J/g). These low latent heat liquids are exemplified by liquid hydrogen. While the system and method disclosed herein are exemplified by the treatment of liquid hydrogen, this disclosure applies to all liquids that have a latent heat of vaporization less than or equal to 1000 J/g. The disclosed secondary storage tank is in fluid communication with the primary storage tank via a fluid stream (hereinafter “stream”). The boil-off gas can be released from the primary storage tank and fed into the secondary storage tank where it is reversibly adsorbed onto a porous sorbent.

In particular, located inside the secondary storage tank is a porous sorbent that offers potential for the efficient capture and storage of the gas associated with boil-off in the primary storage tank (where the gas is stored in liquid form). The porous sorbent is a solid sorbent that has a surface area of 2 m²/gram (g) to 3000 m²/g, 50 to 2000 m²/g, and 100 to 1000 m²/g. Representative porous sorbents include metal-organic frameworks (MOFs), porous coordination polymers (PCPs), covalent organic frameworks (COFs), zeolitic imidazolate frameworks (ZIFs), metal oxides, zeolites, and the like. The porous sorbent can be impregnated with any gas that has a low latent heat of vaporization (e.g., high evaporation rates at the storage temperature of the gas). The storage temperature of the primary storage tank may be any temperature that is economically effective to store the gas at.

In another aspect, disclosed herein is a method of storing a boil-off gas that is released from a primary storage tank into a secondary storage tank. When the liquid boil-off occurs in the primary storage tank, a pressure sensor located in the primary storage tank signals an actuator valve located downstream of the primary storage tank to open, releasing the boil-off gas to the secondary storage tank. As more and more boil-off gas accumulates in the secondary storage tank, the boil-off gas pressure drives physical adsorption on and in the porous sorbent. This adsorbed boil-off gas can subsequently be used in an energy conversion system located downstream of the storage system. The energy conversion system is used to generate energy.

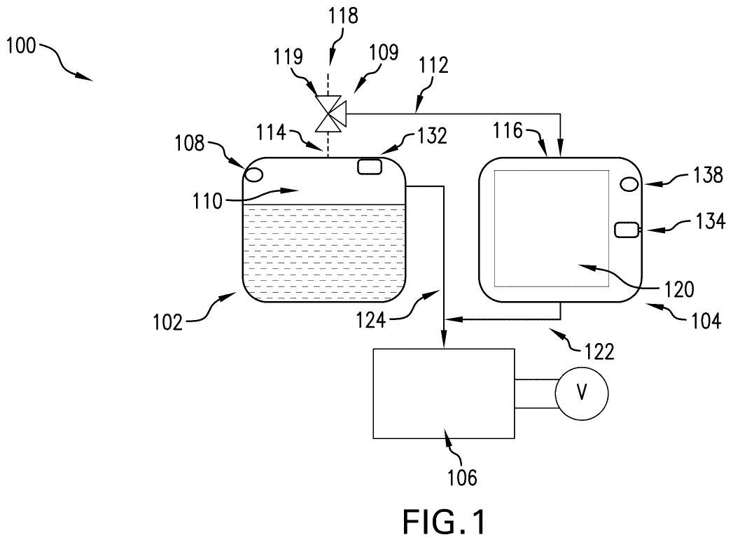

With reference now to FIG. 1, a storage system 100 comprises a primary storage tank 102 and a secondary storage tank 104. An energy conversion system 106 located downstream of the storage system is operative to generate energy. The primary storage tank 102 stores a liquid while the secondary storage tank 104 stores boil-off gas generated in the primary storage tank. The boil-off gas is adsorbed on the porous sorbent and is herein after referred to as “adsorbed boil-off gas”. Upon desorption from the porous sorbent, it is termed “desorbed boil-off gas”. The primary storage tank lies upstream of the secondary storage tank and is in fluid communication with it. The energy conversion system 106 is in fluid communication with both the primary storage tank 102 and secondary storage tank 104 and lies downstream of both the primary storage tank 102 and secondary storage tank 104.

The primary storage tank 102 comprises a filling port (not shown) for filling a liquid into the primary storage tank 102 from a filling line (not shown). The primary storage tank 102 comprises one or more gas outlets 114 for releasing the boil-off gas 110 (hereinafter “boil-off gas”) from the primary storage tank 102 into the secondary storage tank 104 via stream 112. The primary storage tank 102 further comprises a one or more pressure sensors 108 for detecting and monitoring the pressure of boil-off gas within the primary storage tank 102. Located atop the primary storage tank 102 are one or more optional temperature sensors 132 for detecting and monitoring the temperature of boil-off gas within the primary storage tank 102. The primary storage tank includes a vent 118, which is controlled by a pressure relief valve 119 and pressure sensor 108 to release boil-off gas 110 from the primary storage tank 102 in over-pressuring events.

The secondary storage tank 104 is filled with a porous sorbent 120 for the capture and storage of boil-off gas released from the primary storage tank 102. The secondary storage tank 104 further comprises one or more pressure sensors 138 for detecting and monitoring the pressure of boil-off gas within the secondary storage tank 104. The secondary storage tank 104 further comprises one or more optional temperature sensors 134 for detecting and monitoring the temperature of boil-off gas within the secondary storage tank 104.

In some embodiments, the porous sorbent 120 (that is saturated with boil-off gas 110 in the secondary storage tank 104) can be regenerated when the adsorbed boil-off gas 110 is desorbed from the porous sorbent to become a desorbed boil-off gas. The boil-off gas can be desorbed from the porous sorbent by methods such as temperature swing desorption and/or pressure swing desorption. The secondary storage tank 104 is one where the molecules of the boil-off gas have an average lower mean free path than the average mean free path of the identical molecules in the primary storage tank 102. This is because they are more constricted in the pores of the porous sorbent 120 than they are in the primary storage tank where there is no sorbent. The density of the gas in the secondary storage tank 104 is lower than the density of the same gas molecules in the primary storage tank 102.

The porous sorbent 120 located inside the secondary storage tank will now be detailed. In some embodiments, the porous sorbent 120 comprises metal organic frameworks (MOFs), activated carbons, aluminophosphates, conjugated microporous polymers (CMP), covalent-organic frameworks (COFs), crystalline open frameworks, crystalline porous materials, hyper crossed-linked polymer (HCP), metal-organic materials (MOM), microporous polymer network (MPN), organic molecular solids, polyaromatic frameworks (PAFs), polymer with intrinsic microporosity (PIM), porous aromatic framework (PAF), porous coordination networks (PCN), porous coordination polymers (PCPs), porous organic polymer (POP), porous polymer network (PPN), silica particles, silico-alumino-phosphates (SAPOs), zeolites, porous zeolites, zeolitic imidazolate frameworks (ZIFs), porous metal oxides, or a combination comprising at least one of the foregoing.

In an exemplary embodiment, the porous sorbent includes metal organic frameworks (MOFs). As disclosed herein, metal-organic frameworks are a class of compounds including metal ions or metal clusters coordinated to organic linkers to form one-, two-, or three-dimensional structures. The metal ions or metal clusters act as joints and are bound by multidirectional organic linkers. The metal-organic frameworks of the present disclosure include metal-organic frameworks with a plurality of metal, metal oxide, metal cluster, or metal oxide cluster building units.

In some embodiments, suitable metals, metal ions or clusters include metals and metalloids of varying coordination geometries and oxidation states. In some embodiments, the metal ions or clusters are selected from transition metals, post transition metals, alkali metals, alkaline earth metals, lanthanides, actinides, calcium (Ca), cadmium (Cd), cobalt (Co), chromium (Cr), magnesium (Mg), manganese (Mn), iron (Fe), nickel (Ni), copper (Cu), ruthenium (Ru), zinc (Zn), zirconium (Zr), ions thereof, hydrates thereof, salts thereof, halides thereof, fluorides thereof, chlorides thereof, bromides thereof, iodides thereof, nitrates thereof, acetates thereof, sulfates thereof, phosphates thereof, carbonates thereof, oxides thereof, formates thereof, carboxylates thereof, or combinations comprising at least one of the foregoing.

In one embodiment, the metal ions or clusters are selected from the group consisting of aluminum (Al), antimony (I) (Sb), arsenic (I) (As), barium (Ba), beryllium (Be), bismuth (I) (Bi), bismuth (III) (Bi), bismuth (V) (Bi), cadmium (Cd), calcium (Ca), chromium (Cr), cobalt (II) (Co), cobalt (III) (Co), copper (I) (Cu), copper (II) (Cu), gallium (Ga), germanium (II) (Ge), germanium (IV) (Ge), gold (I) (Au), hafnium (Hf), indium (In), iridium (I) (Ir), iridium (II) (Ir), iron (II) (Fe), iron (III) (Fe), lithium (Li), magnesium (Mg), manganese (Mn), mercury (II) (Hg), molybdenum (Mo), nickel (II) (Ni), nickel (Ni), niobium (Nb), osmium (II) (Os), osmium (III) (Os), palladium (I) (Pd), palladium (II) (Pd), platinum (I) (Pt), platinum (II) (Pt), rhenium (II) (Re), rhenium (III) (Re), rhodium (I) (Rh), rhodium (II) (Rh), rubidium (Rb), ruthenium (II) (Ru), ruthenium (III) (Ru), scandium (Sc), silicon (II) (Si), silicon (IV) (Si), silver (Ag), sodium (Na), strontium (Sr), tantalum (Ta), thallium (III) (Tl), tin (II) (Sn), tin (IV) (Sn), titanium (Ti), tungsten (W), yttrium (Y), zinc (II) (Zn), zirconium (Zr), Vanadium (V), Technetium (Tc), Lanthanum (La), Actinium (Ac), or a combination comprising at least one of the foregoing.

The metal ions or clusters are connected (e.g., covalently, ionically, or a combination thereof) by organic linkers to form a porous structure. In some embodiments, the organic linker is a linker selected from the group consisting of polytopic linkers, ditopic linkers, tritopic linkers, tetratopic linkers, pentatopic linkers, hexatopic linkers, heptatopic linkers, octatopic linkers, mixed linkers, desymmetrized linkers, metallo linkers, N-heterocyclic linkers, or a combination comprising at least one of the foregoing.

In some embodiments, the organic linker is a linker selected from the group consisting of 1,3,5-benzenetribenzoate (BTB), 1,4-benzenedicarboxylic acid, 1,4-bis(carboxymethyl) piperazine-2,3-dicarboxylic acid, 1,4-bis-(phenylamino)benzene-2,5-dicarboxylic acid, 1,4-butanedicarboxylic acid, 1,4-cyclohexanedicarboxylic acid, 1,5-dioxide-2,6-naphthalenedicarboxylate (dondc), 1,6-hexanedicarboxylic acid, 1,7-heptanedicarboxylic acid, 1,8-heptadecanedicarboxylic acid, 1,8-naphthalenedicarboxylic acid, 1,9-heptadecanedicarboxylic acid, 2,2′-biquinoline-4,4′-dicarboxylic acid, 2,4-pyridinedicarboxylate, 2,5-dioxidobenzene-1,4-dicarboxylate (dobdc), 2,5-pyridinedicarboxylic acid, 2,6 naphthalene dicarboxylate, 2,6-naphthalene dicarboxylic acid, 2-hydroxy-1,2,3-propanetricarboxylic acid, 2-isopropylimidazole-4,5-dicarboxylic acid, 2-methylimidazole-4,5-dicarboxylic acid, 2-methylquinoline-3,4-dicarboxylic acid, 2-nitrobenzene-1,4-dicarboxylic acid, 4,4′-diaminophenylmethane-3,3′-dicarboxylic acid, 4,4′-dihydroxyazobenzene-3,3′-dicarboxylic acid, 4,4′-dihydroxydiphenylmethane-3,3′-dicarboxylic acid, 4,4′-diaminodiphenyl-3,3′-dicarboxylic acid, 4,4′-dioxidobiphenyl-3,3′-dicarboxylate (dobpdc), 4,4′-dioxido-3,3′-biphenyldicarboxylate, 4,4′-dioxido-3,3′-triphenyldicarboxyl (dotpdc), 4,5-imidazoledicarboxylic acid, 4,6-dihydroxyisophthalic acid, 4-aminophenyl-1H-tetrazole, 4-cyclohexene-1,2-dicarboxylic acid, 4-oxopyran-2,6-dicarboxylic acid, 5,5-dioxodibenzothiophene-3,7-dicarboxylic acid, 5,6-dehydronorbomane-2.3-dicarboxylic acid, 5,6-dimethyl-2,3-pyrazinedicarboxylic acid, 5-ethyl-2,3-pyridinedicarboxylic acid, 5-hydroxy-1,3-benzenedicarboxylic acid, 5-t-butyl-1,3-benzenedicarboxylic acid, 6-chloroquinoxaline-2,3-dicarboxylic acid, 6-pyridinedi carboxy lie acid, 7,8-quinolinecarboxylic acid, 7-chloro-2,3,8-quinolinetricarboxylic acid, 7-chloro-3-methylquinoline-6,8-dicarboxylic acid, 7-chloro-4-hydroxyquinoline-2,8-dicarboxylic acid, 7-chloro-8-methylquinoline-2,3-dicarboxylic acid, 7-chloroquinoline-3,8-dicarboxylic acid, 8-tetracarboxy lie acid, 8-methoxy-2,3-naphthalenedicarboxylic acid, 8-nitro-2,3-naphthalenedicarboxylic acid, 8-sulfo-2,3-naphthalenedicarboxylic acid, acetylene dicarboxylate, acetylenedicarboxylic acid, adamantanedicarboxylic acid, adamantanetetracarboxylate, adamantanetribenzoate, anthracene-2,3-dicarboxylic acid, anthraquinone-1,5-dicarboxylic acid, aurinetricarboxylic acid, benzene dicarboxylate, benzenedicarboxylic acid, benzenetetracarboxylic acid, benzenetribenzoate, benzenetricarboxylate, benzenetricarboxylic acid, benzidine-3,3′-dicarboxylic acid, benzophenonetetracarboxylic acid, biphenyl dicarboxylate, biphenyl-4,4′-dicarboxylate, butanetetracarboxylic acid, butanetricarboxylic acid, cyclobutane-1,1-dicarboxylic acid, cyclobutyl dodecyl terephthalate, cyclohexene-2,3-dicarboxylic acid, cyclopentane-1,2,3,4-tetracarboxylic acid, cyclopentanetetracarboxylic acids, decanedicarboxylic acid, dicarboxylic acid, diimidedicarboxylic acid, dioxaoctanedicarboxylic acid, dioxybiphenyl-2,2′-dicarboxylate, diphenylether-4,4′-dicarboxylic acid, eicosenedicarboxylic acid, furan-2,5-dicarboxylic acid, heptadecanedicarboxylic acid, hexanetetracarboxylic acid, hexatriacontanedicarboxylic acid, imidazole-2,4-dicarboxylic acid, imidazole-4,5-dicarboxylic acid, 1-benzyl-1H-pyrrole-3,4-dicarboxylic acid, 1-methylpyrrole-3,4-dicarboxylic acid, naphtalenedicarboxylate, naphthalene-1,8-dicarboxylic acid, naphthalenedicarboxylic acid, o-hydroxybenzophenonedicarboxylic acid, octanedicarboxylic acid, octanetetracarboxylic acid, p-benzenedicarboxylic acid, pentane-3,3-carboxylic acid, perylene-3.4.9,10-tetracarboxylic acid, perylene-3,9-dicarboxylic acid, perylenedicarboxylic acid, perylene-1,12-sulfone-3,4,9,10-tetracarboxylic acid, perylenetetracarboxylic acids, phenylindanedicarboxylic acid, propanetricarboxylic acid, pyrazine-2,3-dicarboxylic acid, pyrazinedicarboxylic acid, pyrazole-3,4-dicarboxylic acid, pyrazoledicarboxylic acid, pyrene 2,7-dicarboxylate, pyridine-2,3-dicarboxylic acid, pyridine-2,6-dicarboxylic acid, pyridine-3,4-dicarboxylic acid, pyridinedicarboxylic acid, quinoline-2,4-dicarboxylic acid, quinoline-3,4-dicarboxylic acid, quinoxaline-2,3-dicarboxylic acid, terephthalic acid, terphenyl dicarboxylate, tetradecanedicarboxylic acid, tetrahydrofurantetracarboxylic acid, tetrahydropyran-4,4-dicarboxylic acid, tetrahydropyrene 2,7-dicarboxylate (HPDC), tetrazolates, thiophene-3,4-dicarboxylic acid, tricarboxylates, trioxaundecanedicarboxylic acid, 2,5-dioxido-1,4-benzenedicarboxylate, 4,6-dioxido-1,3-benzenedicarboxylate, or a combination comprising at least one of the foregoing.

In some embodiments, the disclosed metal-organic frameworks comprise a plurality of different types of metal ions or clusters, and/or a plurality of different types of organic linkers. In some embodiments, the disclosed metal-organic frameworks comprise organic linkers that are connected to two or more metal ions or clusters that comprise different metals, metal ions, or metal clusters.

In some embodiments, the disclosed metal-organic frameworks comprise metal ions or clusters that are connected by two or more types of different organic linkers, wherein the different types of organic linkers modify the chemical and physical properties of a metal-organic framework disclosed herein. The disclosed metal-organic frameworks are multivariate in that the material properties can be readily modified by changing the ratio between multiple types of metal ions or clusters or the type or ratio between multiple types of organic linkers.

In some embodiments, the metal-organic framework is selected from HKUST-1 (CAS ID: 222404-02-6), KAUST-7 (CAS ID: 1973399-07-3), MIL-100 (Fe) (CAS ID: 1195763-37-1), MOF 5 (CAS ID: 255367-66-9), MOF-274, MOF-303, M₂ (dobdc) (M=Mg, Mn, Fe, Co, Ni, Cu, Zn; dobdc⁴⁻=2,5-dioxido-1,4-benzenedicarboxylate) (also known as CPO-27, and MOF-74), MOF-808, UiO-66 (CAS ID: 1072413-89-8), UiO-67, ZIF-7 (CAS ID: 909531-29-9), ZIF-8 (CAS ID: 59061-53-9), ZIF-90 (CAS ID: 1062147-37-8), and combinations comprising at least one of the foregoing.

In some embodiments, the metal-organic framework is M₂ (m-dobdc) (M=Mn, Fe, Co, Ni; dobdc⁴⁻=4,6-dioxido-1,3-benzenedicarboxylate). In some embodiments, the metal-organic framework is selected from the group consisting of Mn₂ (m-dobdc), Fe₂ (m-dobdc), Co₂ (m-dobdc), and Ni₂ (m-dobdc). In some embodiments, the metal-organic framework is Ni₂ (m-dobdc).

In some embodiments, the surface area of the disclosed metal-organic frameworks can be at least 2 m²/g, or at least 20 m²/g, at least 200 m²/g, at least 500 m²/g, at least 600 m²/g, at least 700 m²/g, at least 800 m²/g, at least 850 m²/g, at least 900 m²/g, at least 950 m²/g, at least 1000 m²/g, at least 1050 m²/g, at least 1100 m²/g, at least 1150 m²/g, at least 1200 m²/g, at least 1250 m²/g, at least 1300 m²/g, at least 1350 m²/g, at least 1400 m²/g, at least 1500 m²/g, at least 1800 m²/g, at least 2000 m²/g, or at least 3000 m²/g.

In one embodiment, the disclosed metal-organic frameworks comprise pores having a pore volume from about 0.1 cm³/g to about 2 cm³/g, 0.25 cm³/g to about 2 cm³/g, 0.5 cm³/g to about 2 cm³/g, 0.75 cm³/g to about 2 cm³/g, 1.0 cm³/g to about 3 cm³/g, 1.25 cm³/g to about 3 cm³/g, 1.5 cm³/g to about 3.5 cm³/g, 1.75 cm³/g to about 4 cm³/g, 2.0 cm³/g to about 4.5 cm³/g, 2.5 cm³/g to about 5 cm³/g, or 3.0 cm³/g to about 6 cm³/g.

In some embodiments, the disclosed metal-organic frameworks can comprise an average particle size of at least 1 nm, or at least 3 nm, or at least 5 nm, or at least 8 nm, or at least 10 nm, or at least 15 nm, or at least 20 nm, or at least 30 nm, or at least 40 nm, or at least 50 nm, or at least 60 nm, or at least 70 nm, or at least 80 nm, or at least 90 nm, or at least 100 nm, or at least 150 nm, or at least 200 nm, or at least 250 nm, or at least 300 nm, or at least 400 nm, or at least 500 nm, or at least 600 nm, or at least 700 nm, or at least 800 nm, or at least 900 nm, or at least 1000 nm.

In some embodiments, the disclosed metal-organic frameworks can comprise an average particle size of at least 1 μm, or at least 3 μm, or at least 5 μm, or at least 8 μm, or at least 10 μm, or at least 15 μm, or at least 20 μm, or at least 30 μm, or at least 40 μm, or at least 50 μm, or at least 60 μm, or at least 70 μm, or at least 80 μm, or at least 90 μm, or at least 100 μm, or at least 150 μm, or at least 200 μm, or at least 250 μm, or at least 300 μm, or at least 400 μm, or at least 500 μm, or at least 600 μm, or at least 700 μm, or at least 800 μm, or at least 900 μm, or at least 1000 μm.

In some embodiments, the disclosed metal-organic frameworks may have a hydrogen gravimetric capacity (amount of hydrogen that a material can store per unit of its mass) of at least 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15 weight percentage (wt) %.

In some embodiments, the temperature of the primary storage tank 102 and the secondary storage tank 104 can be moderated by a heater (e.g., a thermal heater, an electric heater, a convection heater, infrared heater, induction heaters, and the like) or cooler (e.g., cryogenic jacket, closed loop coolant system, and the like).

In some embodiments, the internal temperature of the primary storage tank 102 ranges from approximately −253° C. to −250° C. The temperature of the boil-off gas 110 can range from −250° C. to −230° C. Surrounding the primary storage tank 102, the multi-layer insulation experiences a thermal gradient, with temperatures ranging from about −200° C. near the cold side to −100° C. toward the outer edge.

In some embodiments, the internal temperature of the secondary storage tank 104 is at an “ambient temperature” of 15° C. to 35° C., and 20 to 30° C. In some embodiments, the internal temperature of the secondary storage tank 104 is at a “near-ambient temperature” of 0° C. to 15° C., or 25° C. up to about 40° C.

In some embodiments, in using the system 100, when boil-off occurs and boil-off gas build-up occurs in the primary storage tank 102, a pressure sensor 108 signals the actuator valve 109 to open, releasing the boil-off gas 110 from the primary storage tank 102 into the secondary storage tank 104 via stream 112 that extends from a gas outlet 114 of the primary storage tank 102 to a gas inlet 116 of the secondary storage tank 104. As more and more boil-off gas 110 accumulates in the secondary storage tank 104, the gas pressure drives physical adsorption of boil-off gas 110 on and in the porous sorbent 120. The adsorbed boil-off gas 110 can be subsequently released from the porous sorbent 120 to become a desorbed boil-off gas and be charged into an energy conversion system 106 located downstream of both the primary storage tank and the secondary storage tank 104 via stream 122. The stream 122 includes a flow meter (not shown) for detecting a flow rate of the desorbed boil-off gas discharged from the secondary storage tank 104. The stream 122 includes a flow rate control valve (not shown) that adjusts the flow rate of the desorbed boil-off gas sent from the secondary storage tank into the energy conversion system. The stream 122 further includes a compressor (not shown) that pressurizes the desorbed boil-off gas discharged from the secondary storage tank 104.

In some embodiments, the boil-off gas 110 along with liquid in the primary storage tank 102 can be released from the primary storage tank 102 and fed into the energy conversion system 106 via stream 124. The stream 124 includes a flow meter (not shown) for detecting a flow rate of the boil-off gas discharged from the secondary storage tank 104. The stream 124 includes a flow rate control valve (not shown) that adjusts the flow rate of the boil-off gas sent from the primary storage tank 102 into the energy conversion system. The stream 124 further includes a compressor (not shown) that pressurizes the desorbed boil-off gas discharged from the secondary storage tank 104.

As noted above, the primary storage tank may be used to store a variety of different gases in liquid form. Examples of gases (that are stored in the primary storage tank in liquid form) having low latent heat of vaporization below 1000 J/g that may be stored in the system 100 include natural gas, methane, carbon dioxide, carbon monoxide, hydrogen, oxygen, nitrogen, helium, neon, argon, krypton, xenon, ethane, ethylene, acetylene, propane, propylene, butane, 2-methylpropane, 1-butene, cis-2-butene, trans-2-butene, 2-methylpropene, sulfur dioxide, sulfur trioxide, nitrogen oxide, nitrogen dioxide, or other adsorbates in a gas phase. In an exemplary embodiment, the liquid stored in the primary storage tank is hydrogen.

The disclosed boil-off gas capture and storage system can be used anywhere a portable or mobile storage system for liquids having low latent heat of vaporization below 1000 joules per gram (J/g) is used. In some embodiments, the energy conversion system 106 may be a hydrogen-based propulsion system, which may comprise either a fuel cell or a hydrogen internal combustion engine (HICE). Fuel cell systems generally include a fuel cell stack that produces electrical energy based on a reaction between a hydrogen gas and an oxidant gas (e.g., oxygen-containing air). The hydrogen gas and oxidant gas are supplied to the fuel cell stack at appropriate operating conditions (i.e., temperature and pressure), wherein the gases participate in an electrochemical reaction across an electrolyte to produce electrical power, with water and heat as byproducts. The hydrogen internal combustion engines generally include an engine that produces mechanical energy based on the combustion of hydrogen within the engine's cylinders in a manner similar to traditional gasoline or diesel engines, typically using modified fuel injection and ignition systems to accommodate hydrogen's unique combustion characteristics. The hydrogen-based feed gas is supplied to the ICE at appropriate operating conditions (i.e., temperature and pressure) for being combusted.

The energy conversion system 106 may also include a gas turbine where gases are combusted to generate energy in the form of electricity.

The disclosed storage system can be used on any means of transportation vehicles, including but not limited to passenger cars, trucks, buses, agricultural equipment (e.g., tractors, harvesters), construction machinery (e.g., excavators, bulldozers, loaders), mining vehicles (e.g., drilling rigs, haul trucks), and manufacturing equipment (e.g., robotic arms, conveyors, heavy-duty presses), manned and unmanned aircraft, including small drones, regional airplanes, and hybrid-electric propulsion systems for larger aircraft. In an embodiment, the disclosed storage system may be advantageously used on seaworthy vessels such as ships, where the hydrogen can be used to drive the propulsion system. In an embodiment, the disclosed storage system may be used on ships transporting liquid hydrogen. The system may be used to prevent the venting of boil-off gas by capturing and storing it on board.

The storage system may be coupled with an onboard energy conversion system, and power management modules to ensure continuous and reliable operation of transportation vehicles.

In some embodiments, the energy conversion system can be a power unit of a stationary liquid hydrogen fuel system such as may be used to provide power to a building or other stationary structure. In other embodiments, the system is not part of an energy conversion system but is instead part of a liquid hydrogen transfer system.

The following examples are intended only to illustrate the disclosure. Other synthetic processes, assays, studies, protocols, procedures, methodologies, techniques, reagents and conditions may alternatively be used as appropriate.

### Example 1

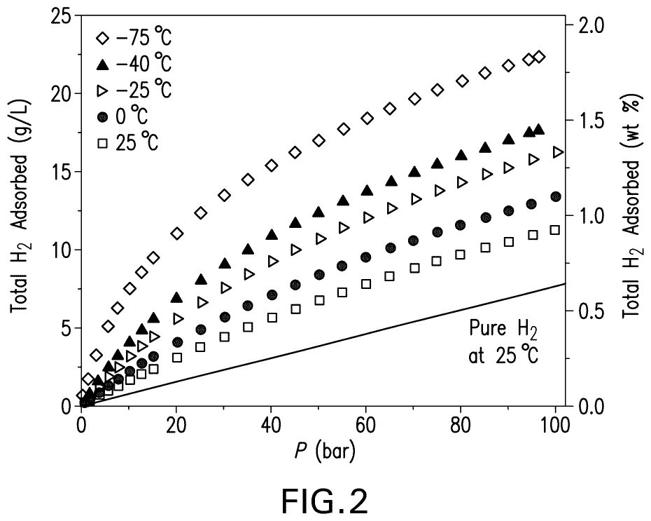

Referring to FIG. 2, this example is conducted to demonstrate the hydrogen adsorption of a porous sorbent 120 in the secondary storage tank 104. The hydrogen adsorption varies with pressure (P, in bar) and temperature (in ° C.). Higher pressures lead to more hydrogen adsorption and lower temperatures greatly enhance hydrogen adsorption. Adsorption increases rapidly at lower pressures, but the rate of increase slows at higher pressures (indicative of approaching saturation behavior).

Set forth below are some embodiments of the foregoing disclosure:

Embodiment 1: A storage system for storing low latent heat of vaporization gases, the system comprising a primary storage tank for storing a liquid having a latent heat of vaporization of less than or equal to 1000 joules per gram, and a secondary storage tank comprising a porous sorbent for reversibly storing a boil-off gas released from the primary storage tank.

Embodiment 2: The storage system as in any prior embodiment, wherein the storage system further comprises an energy conversion system in fluid communication with both the primary storage tank and the secondary storage tank; wherein the energy conversion system is operative to receive the liquid from the primary storage tank and a desorbed boil-off gas from the secondary storage tank; and wherein the energy conversion system is operative to generate energy.

Embodiment 3: The storage system as in any prior embodiment, wherein the porous sorbent is selected from the group consisting of an activated carbon, an aluminophosphate, a conjugated microporous polymer, a covalent-organic framework, a crystalline open framework, a crystalline porous material, a hyper crossed-linked polymer, a metal organic framework, a metal-organic material, a microporous polymer network, an organic molecular solid, a polyaromatic framework, a polymer with intrinsic microporosity, a porous aromatic framework, a porous coordination network, a porous coordination polymer, a porous organic polymer, a porous polymer network, a silica particle, a silico-alumino-phosphate, a zeolite, a zeolitic imidazolate framework, a porous metal oxide, or a combination comprising at least one of the foregoing porous sorbents.

Embodiment 4: The storage system as in any prior embodiment, wherein the metal organic framework comprises a metal cluster and an organic linker.

Embodiment 5: The storage system as in any prior embodiment, wherein the metal cluster is selected from the group consisting of a transition metal, a post transition metal, an alkali metal, an alkaline earth metal, a lanthanide, a actinide, calcium, cadmium, cobalt, chromium, magnesium, manganese, iron, nickel, copper, ruthenium, zinc, zirconium, an ion thereof, a hydrate thereof, a salt thereof, a halide thereof, a fluoride thereof, a chloride thereof, a bromide thereof, an iodide thereof, a nitrate thereof, an acetate thereof, a sulfate thereof, a phosphate thereof, a carbonate thereof, an oxide thereof, a formate thereof, a carboxylate thereof, or a combination comprising at least one of the foregoing.

Embodiment 6: The storage system as in any prior embodiment, wherein the organic linker is selected from the group consisting of 1,3,5-benzenetribenzoate, 1,4-benzenedicarboxylic acid, 1,4-bis(carboxymethyl) piperazine-2,3-dicarboxylic acid, 1,4-bis-(phenylamino)benzene-2,5-dicarboxylic acid, 1,4-butanedicarboxylic acid, 1,4-cyclohexanedicarboxylic acid, 1,5-dioxide-2,6-naphthalenedicarboxylate, 1,6-hexanedicarboxylic acid, 1,7-heptanedicarboxylic acid, 1,8-heptadecanedicarboxylic acid, 1,8-naphthalenedicarboxylic acid, 1,9-heptadecanedicarboxylic acid, 2,2′-biquinoline-4,4′-dicarboxylic acid, 2,4-pyridinedicarboxylate, 2,5-dioxidobenzene-1,4-dicarboxylate, 2,5-pyridinedicarboxylic acid, 2,6 naphthalene dicarboxylate, 2,6-naphthalene dicarboxylic acid, 2-hydroxy-1,2,3-propanetricarboxylic acid, 2-isopropylimidazole-4,5-dicarboxylic acid, 2-methylimidazole-4,5-dicarboxylic acid, 2-methylquinoline-3,4-dicarboxylic acid, 2-nitrobenzene-1,4-dicarboxylic acid, 4,4′-diaminophenylmethane-3,3′-dicarboxylic acid, 4,4′-dihydroxyazobenzene-3,3′-dicarboxylic acid, 4,4′-dihydroxydiphenylmethane-3,3′-dicarboxylic acid, 4,4′-diaminodiphenyl-3,3′-dicarboxylic acid, 4,4′-dioxidobiphenyl-3,3′-dicarboxylate, 4,4′-dioxido-3,3′-biphenyldicarboxylate, 4,4′-dioxido-3,3′-triphenyldicarboxyl, 4,5-imidazoledicarboxylic acid, 4,6-dihydroxyisophthalic acid, 4-aminophenyl-1H-tetrazole, 4-cyclohexene-1,2-dicarboxylic acid, 4-oxopyran-2,6-dicarboxylic acid, 5,5-dioxodibenzothiophene-3,7-dicarboxylic acid, 5,6-dehydronorbomane-2.3-dicarboxylic acid, 5,6-dimethyl-2,3-pyrazinedicarboxylic acid, 5-ethyl-2,3-pyridinedicarboxylic acid, 5-hydroxy-1,3-benzenedicarboxylic acid, 5-t-butyl-1,3-benzenedicarboxylic acid, 6-chloroquinoxaline-2,3-dicarboxylic acid, 6-pyridinedi carboxy lie acid, 7,8-quinolinecarboxylic acid, 7-chloro-2,3,8-quinolinetricarboxylic acid, 7-chloro-3-methylquinoline-6,8-dicarboxylic acid, 7-chloro-4-hydroxyquinoline-2,8-dicarboxylic acid, 7-chloro-8-methylquinoline-2,3-dicarboxylic acid, 7-chloroquinoline-3,8-dicarboxylic acid, 8-tetracarboxy lie acid, 8-methoxy-2,3-naphthalenedicarboxylic acid, 8-nitro-2,3-naphthalenedicarboxylic acid, 8-sulfo-2,3-naphthalenedicarboxylic acid, acetylene dicarboxylate, acetylenedicarboxylic acid, adamantanedicarboxylic acid, adamantanetetracarboxylate, adamantanetribenzoate, anthracene-2,3-dicarboxylic acid, anthraquinone-1,5-dicarboxylic acid, aurinetricarboxylic acid, benzene dicarboxylate, benzenedicarboxylic acid, benzenetetracarboxylic acid, benzenetribenzoate, benzenetricarboxylate, benzenetricarboxylic acid, benzidine-3,3′-dicarboxylic acid, benzophenonetetracarboxylic acid, biphenyl dicarboxylate, biphenyl-4,4′-dicarboxylate, butanetetracarboxylic acid, butanetricarboxylic acid, cyclobutane-1,1-dicarboxylic acid, cyclobutyl dodecyl terephthalate, cyclohexene-2,3-dicarboxylic acid, cyclopentane-1,2,3,4-tetracarboxylic acid, cyclopentanetetracarboxylic acids, decanedicarboxylic acid, dicarboxylic acid, diimidedicarboxylic acid, dioxaoctanedicarboxylic acid, dioxybiphenyl-2,2′-dicarboxylate, diphenylether-4,4′-dicarboxylic acid, eicosenedicarboxylic acid, furan-2,5-dicarboxylic acid, heptadecanedicarboxylic acid, hexanetetracarboxylic acid, hexatriacontanedicarboxylic acid, imidazole-2,4-dicarboxylic acid, imidazole-4,5-dicarboxylic acid, 1-benzyl-1H-pyrrole-3,4-dicarboxylic acid, 1-methylpyrrole-3,4-dicarboxylic acid, naphtalenedicarboxylate, naphthalene-1,8-dicarboxylic acid, naphthalenedicarboxylic acid, o-hydroxybenzophenonedicarboxylic acid, octanedicarboxylic acid, octanetetracarboxylic acid, p-benzenedicarboxylic acid, pentane-3,3-carboxylic acid, perylene-3.4.9,10-tetracarboxylic acid, perylene-3,9-dicarboxylic acid, perylenedicarboxylic acid, perylene-1,12-sulfone-3,4,9,10-tetracarboxylic acid, perylenetetracarboxylic acids, phenylindanedicarboxylic acid, propanetricarboxylic acid, pyrazine-2,3-dicarboxylic acid, pyrazinedicarboxylic acid, pyrazole-3,4-dicarboxylic acid, pyrazoledicarboxylic acid, pyrene 2,7-dicarboxylate, pyridine-2,3-dicarboxylic acid, pyridine-2,6-dicarboxylic acid, pyridine-3,4-dicarboxylic acid, pyridinedicarboxylic acid, quinoline-2,4-dicarboxylic acid, quinoline-3,4-dicarboxylic acid, quinoxaline-2,3-dicarboxylic acid, terephthalic acid, terphenyl dicarboxylate, tetradecanedicarboxylic acid, tetrahydrofurantetracarboxylic acid, tetrahydropyran-4,4-dicarboxylic acid, tetrahydropyrene 2,7-dicarboxylate, tetrazolates, thiophene-3,4-dicarboxylic acid, tricarboxylates, trioxaundecanedicarboxylic acid, 2,5-dioxido-1,4-benzenedicarboxylate, 4,6-dioxido-1,3-benzenedicarboxylate, or a combination comprising at least one of the foregoing linkers.

Embodiment 7: The storage system as in any prior embodiment, wherein the metal cluster comprises manganese, iron, cobalt, and nickel, and wherein the organic linker comprises at least one of 2,5-dioxido-1,4-benzenedicarboxylate or 4,6-dioxido-1,3-benzenedicarboxylate.

Embodiment 8: The storage system as in any prior embodiment, wherein the primary storage tank further comprises a pressure sensor operative to detect pressure of the boil-off gas within the primary storage tank; and wherein the secondary storage tank further comprises a pressure sensor operative to detect pressure of the desorbed boil-off gas within the secondary storage tank.

Embodiment 9: The storage system as in any prior embodiment, wherein the liquid comprises liquid hydrogen.

Embodiment 10: The storage system as in any prior embodiment, wherein the energy conversion system comprises a propulsion system, a fuel cell, a gas turbine, or an internal combustion engine.

Embodiment 11: A method of storing low latent heat of vaporization gases, the method comprising discharging a boil-off gas released from a primary storage tank to a secondary storage tank; wherein the primary storage tank is operative to store a liquid having a latent heat of vaporization of less than or equal to 1000 joules per gram; and wherein the secondary storage tank comprises a porous sorbent for reversibly storing the boil-off gas discharged from the primary storage tank.

Embodiment 12: The method as in any prior embodiment, further comprising discharging a desorbed boil-off gas from the secondary storage tank to an energy conversion system; wherein the energy conversion system comprises a propulsion system, a fuel cell, a gas turbine, or an internal combustion engine.

Embodiment 13: The method as in any prior embodiment, further comprising discharging the liquid from the primary storage tank directly to the energy conversion system.

Embodiment 14: The method as in any prior embodiment, wherein the boil-off gas is discharged to the secondary storage tank via a relief valve.

Embodiment 15: The method as in any prior embodiment, wherein the energy conversion system is operative to generate energy.

Embodiment 16: The method as in any prior embodiment, wherein the porous sorbent is selected from the group consisting of an activated carbon, an aluminophosphate, a conjugated microporous polymer, a covalent-organic framework, a crystalline open framework, a crystalline porous material, a hyper crossed-linked polymer, a metal organic framework, a metal-organic material, a microporous polymer network, an organic molecular solid, a polyaromatic framework, a polymer with intrinsic microporosity, a porous aromatic framework, a porous coordination network, a porous coordination polymer, a porous organic polymer, a porous polymer network, a silica particle, a silico-alumino-phosphate, a zeolite, a zeolitic imidazolate framework, a porous metal oxide, or a combination comprising at least one of the foregoing porous sorbents.

Embodiment 17: The method as in any prior embodiment, wherein the metal organic framework comprises a metal cluster and an organic linker.

Embodiment 18: The method as in any prior embodiment, wherein the metal cluster is selected from the group consisting of a transition metal, a post transition metal, an alkali metal, an alkaline earth metal, a lanthanide, a actinide, calcium, cadmium, cobalt, chromium, magnesium, manganese, iron, nickel, copper, ruthenium, zinc, zirconium, an ion thereof, a hydrate thereof, a salt thereof, a halide thereof, a fluoride thereof, a chloride thereof, a bromide thereof, an iodide thereof, a nitrate thereof, an acetate thereof, a sulfate thereof, a phosphate thereof, a carbonate thereof, an oxide thereof, a formate thereof, a carboxylate thereof, or a combination comprising at least one of the foregoing.

Embodiment 19: The method as in any prior embodiment, wherein the organic linker is selected from the group consisting of f 1,3,5-benzenetribenzoate, 1,4-benzenedicarboxylic acid, 1,4-bis(carboxymethyl) piperazine-2,3-dicarboxylic acid, 1,4-bis-(phenylamino)benzene-2,5-dicarboxylic acid, 1,4-butanedicarboxylic acid, 1,4-cyclohexanedicarboxylic acid, 1,5-dioxide-2,6-naphthalenedicarboxylate, 1,6-hexanedicarboxylic acid, 1,7-heptanedicarboxylic acid, 1,8-heptadecanedicarboxylic acid, 1,8-naphthalenedicarboxylic acid, 1,9-heptadecanedicarboxylic acid, 2,2′-biquinoline-4,4′-dicarboxylic acid, 2,4-pyridinedicarboxylate, 2,5-dioxidobenzene-1,4-dicarboxylate, 2,5-pyridinedicarboxylic acid, 2,6 naphthalene dicarboxylate, 2,6-naphthalene dicarboxylic acid, 2-hydroxy-1,2,3-propanetricarboxylic acid, 2-isopropylimidazole-4,5-dicarboxylic acid, 2-methylimidazole-4,5-dicarboxylic acid, 2-methylquinoline-3,4-dicarboxylic acid, 2-nitrobenzene-1,4-dicarboxylic acid, 4,4′-diaminophenylmethane-3,3′-dicarboxylic acid, 4,4′-dihydroxyazobenzene-3,3′-dicarboxylic acid, 4,4′-dihydroxydiphenylmethane-3,3′-dicarboxylic acid, 4,4′-diaminodiphenyl-3,3′-dicarboxylic acid, 4,4′-dioxidobiphenyl-3,3′-dicarboxylate, 4,4′-dioxido-3,3′-biphenyldicarboxylate, 4,4′-dioxido-3,3′-triphenyldicarboxyl, 4,5-imidazoledicarboxylic acid, 4,6-dihydroxyisophthalic acid, 4-aminophenyl-1H-tetrazole, 4-cyclohexene-1,2-dicarboxylic acid, 4-oxopyran-2,6-dicarboxylic acid, 5,5-dioxodibenzothiophene-3,7-dicarboxylic acid, 5,6-dehydronorbomane-2.3-dicarboxylic acid, 5,6-dimethyl-2,3-pyrazinedicarboxylic acid, 5-ethyl-2,3-pyridinedicarboxylic acid, 5-hydroxy-1,3-benzenedicarboxylic acid, 5-t-butyl-1,3-benzenedicarboxylic acid, 6-chloroquinoxaline-2,3-dicarboxylic acid, 6-pyridinedi carboxy lie acid, 7,8-quinolinecarboxylic acid, 7-chloro-2,3,8-quinolinetricarboxylic acid, 7-chloro-3-methylquinoline-6,8-dicarboxylic acid, 7-chloro-4-hydroxyquinoline-2,8-dicarboxylic acid, 7-chloro-8-methylquinoline-2,3-dicarboxylic acid, 7-chloroquinoline-3,8-dicarboxylic acid, 8-tetracarboxy lie acid, 8-methoxy-2,3-naphthalenedicarboxylic acid, 8-nitro-2,3-naphthalenedicarboxylic acid, 8-sulfo-2,3-naphthalenedicarboxylic acid, acetylene dicarboxylate, acetylenedicarboxylic acid, adamantanedicarboxylic acid, adamantanetetracarboxylate, adamantanetribenzoate, anthracene-2,3-dicarboxylic acid, anthraquinone-1,5-dicarboxylic acid, aurinetricarboxylic acid, benzene dicarboxylate, benzenedicarboxylic acid, benzenetetracarboxylic acid, benzenetribenzoate, benzenetricarboxylate, benzenetricarboxylic acid, benzidine-3,3′-dicarboxylic acid, benzophenonetetracarboxylic acid, biphenyl dicarboxylate, biphenyl-4,4′-dicarboxylate, butanetetracarboxylic acid, butanetricarboxylic acid, cyclobutane-1,1-dicarboxylic acid, cyclobutyl dodecyl terephthalate, cyclohexene-2,3-dicarboxylic acid, cyclopentane-1,2,3,4-tetracarboxylic acid, cyclopentanetetracarboxylic acids, decanedicarboxylic acid, dicarboxylic acid, diimidedicarboxylic acid, dioxaoctanedicarboxylic acid, dioxybiphenyl-2,2′-dicarboxylate, diphenylether-4,4′-dicarboxylic acid, eicosenedicarboxylic acid, furan-2,5-dicarboxylic acid, heptadecanedicarboxylic acid, hexanetetracarboxylic acid, hexatriacontanedicarboxylic acid, imidazole-2,4-dicarboxylic acid, imidazole-4,5-dicarboxylic acid, 1-benzyl-1H-pyrrole-3,4-dicarboxylic acid, 1-methylpyrrole-3,4-dicarboxylic acid, naphtalenedicarboxylate, naphthalene-1,8-dicarboxylic acid, naphthalenedicarboxylic acid, o-hydroxybenzophenonedicarboxylic acid, octanedicarboxylic acid, octanetetracarboxylic acid, p-benzenedicarboxylic acid, pentane-3,3-carboxylic acid, perylene-3.4.9,10-tetracarboxylic acid, perylene-3,9-dicarboxylic acid, perylenedicarboxylic acid, perylene-1,12-sulfone-3,4,9,10-tetracarboxylic acid, perylenetetracarboxylic acids, phenylindanedicarboxylic acid, propanetricarboxylic acid, pyrazine-2,3-dicarboxylic acid, pyrazinedicarboxylic acid, pyrazole-3,4-dicarboxylic acid, pyrazoledicarboxylic acid, pyrene 2,7-dicarboxylate, pyridine-2,3-dicarboxylic acid, pyridine-2,6-dicarboxylic acid, pyridine-3,4-dicarboxylic acid, pyridinedicarboxylic acid, quinoline-2,4-dicarboxylic acid, quinoline-3,4-dicarboxylic acid, quinoxaline-2,3-dicarboxylic acid, terephthalic acid, terphenyl dicarboxylate, tetradecanedicarboxylic acid, tetrahydrofurantetracarboxylic acid, tetrahydropyran-4,4-dicarboxylic acid, tetrahydropyrene 2,7-dicarboxylate, tetrazolates, thiophene-3,4-dicarboxylic acid, tricarboxylates, trioxaundecanedicarboxylic acid, 2,5-dioxido-1,4-benzenedicarboxylate, or a combination comprising at least one of the foregoing linkers.

Embodiment 20: The method as in any prior embodiment, wherein the metal cluster comprises manganese, iron, cobalt, and nickel, and the organic linker comprises at least one of 2,5-dioxido-1,4-benzenedicarboxylate or 4,6-dioxido-1,3-benzenedicarboxylate.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” includes a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

As used herein, a “porous metal oxide” refers to a metal oxide material characterized by a network of interconnected pores, which may be microporous (pore diameter <2 nm), mesoporous (2-50 nm), or macroporous (>50 nm), and which exhibit a high surface area suitable for adsorption, catalysis, or diffusion-controlled processes. The porous metal oxide may comprise, without limitation, oxides of aluminum, titanium, zirconium, cerium, silicon, zinc, magnesium, or combinations thereof. The porosity may be intrinsic to the metal oxide structure or engineered via templating, sol-gel processing, or phase separation techniques.

As used herein, “porous zeolites” refer to crystalline aluminosilicate or alumino-phosphate materials possessing a three-dimensional microporous framework with well-defined pore sizes of 0.3 to 1.5 nanometers. The porous network of zeolites comprises interconnected channels and cavities formed by repeating tetrahedral units (e.g., SiO₄ and AlO₄), which provide high surface area, uniform pore distribution, and shape-selective properties. Zeolites may be employed in their native acidic form or exchanged with metal cations, such as sodium, calcium, or transition metals, to modify catalytic or ion-exchange activity. In certain embodiments, the porous zeolite may serve as a molecular sieve, catalyst, or support structure for active species, with applications in adsorption, hydrocarbon processing, gas separation, or pollutant removal. The framework composition, Si/Al ratio, pore geometry, and surface modification of the zeolite may be tailored to enhance selectivity, stability, and reusability in specific applications.

As used herein, “temperature swing” refers to a process in which the temperature of porous sorbents is cyclically increased and decreased to facilitate the adsorption and desorption of gases. During the adsorption phase at lower temperatures, the gases bind to the porous sorbents. Upon heating, the adsorbed gases are released (desorbed), allowing the porous sorbents to be regenerated for subsequent use.

As used herein, “pressure swing” refers to a process in which the pressure of a gas system is cyclically increased and decreased to enable the selective adsorption and desorption of gases on porous sorbents. At higher pressures, the gases are adsorbed onto the porous sorbents. When the pressure is reduced, the adsorbed gases are released (desorbed), allowing the porous sorbents to be regenerated for reuse.

What is claimed is:

1. A storage system for storing low latent heat of vaporization gases, the system comprising:
a primary storage tank for storing a liquid having a latent heat of vaporization of less than or equal to 1000 joules per gram; and
a secondary storage tank comprising a porous sorbent for reversibly storing a boil-off gas released from the primary storage tank.

2. The storage system of claim 1, wherein the storage system further comprises an energy conversion system in fluid communication with both the primary storage tank and the secondary storage tank; wherein the energy conversion system is operative to receive the liquid from the primary storage tank and a desorbed boil-off gas from the secondary storage tank; and wherein the energy conversion system is operative to generate energy.

3. The storage system of claim 1, wherein the porous sorbent is selected from the group consisting of an activated carbon, an aluminophosphate, a conjugated microporous polymer, a covalent-organic framework, a crystalline open framework, a crystalline porous material, a hyper crossed-linked polymer, a metal organic framework, a metal-organic material, a microporous polymer network, an organic molecular solid, a polyaromatic framework, a polymer with intrinsic microporosity, a porous aromatic framework, a porous coordination network, a porous coordination polymer, a porous organic polymer, a porous polymer network, a silica particle, a silico-alumino-phosphate, a zeolite, a zeolitic imidazolate framework, a porous metal oxide, or a combination comprising at least one of the foregoing porous sorbents.

4. The storage system of claim 3, wherein the metal organic framework comprises a metal cluster and an organic linker.

5. The storage system of claim 4, wherein the metal cluster is selected from the group consisting of a transition metal, a post transition metal, an alkali metal, an alkaline earth metal, a lanthanide, a actinide, calcium, cadmium, cobalt, chromium, magnesium, manganese, iron, nickel, copper, ruthenium, zinc, zirconium, an ion thereof, a hydrate thereof, a salt thereof, a halide thereof, a fluoride thereof, a chloride thereof, a bromide thereof, an iodide thereof, a nitrate thereof, an acetate thereof, a sulfate thereof, a phosphate thereof, a carbonate thereof, an oxide thereof, a formate thereof, a carboxylate thereof, or a combination comprising at least one of the foregoing.

6. The storage system of claim 4, wherein the organic linker is selected from the group consisting of 1,3,5-benzenetribenzoate, 1,4-benzenedicarboxylic acid, 1,4-bis(carboxymethyl) piperazine-2,3-dicarboxylic acid, 1,4-bis-(phenylamino)benzene-2,5-dicarboxylic acid, 1,4-butanedicarboxylic acid, 1,4-cyclohexanedicarboxylic acid, 1,5-dioxide-2,6-naphthalenedicarboxylate, 1,6-hexanedicarboxylic acid, 1,7-heptanedicarboxylic acid, 1,8-heptadecanedicarboxylic acid, 1,8-naphthalenedicarboxylic acid, 1,9-heptadecanedicarboxylic acid, 2,2′-biquinoline-4,4′-dicarboxylic acid, 2,4-pyridinedicarboxylate, 2,5-dioxidobenzene-1,4-dicarboxylate, 2,5-pyridinedicarboxylic acid, 2,6 naphthalene dicarboxylate, 2,6-naphthalene dicarboxylic acid, 2-hydroxy-1,2,3-propanetricarboxylic acid, 2-isopropylimidazole-4,5-dicarboxylic acid, 2-methylimidazole-4,5-dicarboxylic acid, 2-methylquinoline-3,4-dicarboxylic acid, 2-nitrobenzene-1,4-dicarboxylic acid, 4,4′-diaminophenylmethane-3,3′-dicarboxylic acid, 4,4′-dihydroxyazobenzene-3,3′-dicarboxylic acid, 4,4′-dihydroxydiphenylmethane-3,3′-dicarboxylic acid, 4,4′-diaminodiphenyl-3,3′-dicarboxylic acid, 4,4′-dioxidobiphenyl-3,3′-dicarboxylate, 4,4′-dioxido-3,3′-biphenyldicarboxylate, 4,4′-dioxido-3,3′-triphenyldicarboxyl, 4,5-imidazoledicarboxylic acid, 4,6-dihydroxyisophthalic acid, 4-aminophenyl-1H-tetrazole, 4-cyclohexene-1,2-dicarboxylic acid, 4-oxopyran-2,6-dicarboxylic acid, 5,5-dioxodibenzothiophene-3,7-dicarboxylic acid, 5,6-dehydronorbomane-2.3-dicarboxylic acid, 5,6-dimethyl-2,3-pyrazinedicarboxylic acid, 5-ethyl-2,3-pyridinedicarboxylic acid, 5-hydroxy-1,3-benzenedicarboxylic acid, 5-t-butyl-1,3-benzenedicarboxylic acid, 6-chloroquinoxaline-2,3-dicarboxylic acid, 6-pyridinedi carboxy lie acid, 7,8-quinolinecarboxylic acid, 7-chloro-2,3,8-quinolinetricarboxylic acid, 7-chloro-3-methylquinoline-6,8-dicarboxylic acid, 7-chloro-4-hydroxyquinoline-2,8-dicarboxylic acid, 7-chloro-8-methylquinoline-2,3-dicarboxylic acid, 7-chloroquinoline-3,8-dicarboxylic acid, 8-tetracarboxy lie acid, 8-methoxy-2,3-naphthalenedicarboxylic acid, 8-nitro-2,3-naphthalenedicarboxylic acid, 8-sulfo-2,3-naphthalenedicarboxylic acid, acetylene dicarboxylate, acetylenedicarboxylic acid, adamantanedicarboxylic acid, adamantanetetracarboxylate, adamantanetribenzoate, anthracene-2,3-dicarboxylic acid, anthraquinone-1,5-dicarboxylic acid, aurinetricarboxylic acid, benzene dicarboxylate, benzenedicarboxylic acid, benzenetetracarboxylic acid, benzenetribenzoate, benzenetricarboxylate, benzenetricarboxylic acid, benzidine-3,3′-dicarboxylic acid, benzophenonetetracarboxylic acid, biphenyl dicarboxylate, biphenyl-4,4′-dicarboxylate, butanetetracarboxylic acid, butanetricarboxylic acid, cyclobutane-1,1-dicarboxylic acid, cyclobutyl dodecyl terephthalate, cyclohexene-2,3-dicarboxylic acid, cyclopentane-1,2,3,4-tetracarboxylic acid, cyclopentanetetracarboxylic acids, decanedicarboxylic acid, dicarboxylic acid, diimidedicarboxylic acid, dioxaoctanedicarboxylic acid, dioxybiphenyl-2,2′-dicarboxylate, diphenylether-4,4′-dicarboxylic acid, eicosenedicarboxylic acid, furan-2,5-dicarboxylic acid, heptadecanedicarboxylic acid, hexanetetracarboxylic acid, hexatriacontanedicarboxylic acid, imidazole-2,4-dicarboxylic acid, imidazole-4,5-dicarboxylic acid, 1-benzyl-1H-pyrrole-3,4-dicarboxylic acid, 1-methylpyrrole-3,4-dicarboxylic acid, naphtalenedicarboxylate, naphthalene-1,8-dicarboxylic acid, naphthalenedicarboxylic acid, o-hydroxybenzophenonedicarboxylic acid, octanedicarboxylic acid, octanetetracarboxylic acid, p-benzenedicarboxylic acid, pentane-3,3-carboxylic acid, perylene-3.4.9,10-tetracarboxylic acid, perylene-3,9-dicarboxylic acid, perylenedicarboxylic acid, perylene-1,12-sulfone-3,4,9,10-tetracarboxylic acid, perylenetetracarboxylic acids, phenylindanedicarboxylic acid, propanetricarboxylic acid, pyrazine-2,3-dicarboxylic acid, pyrazinedicarboxylic acid, pyrazole-3,4-dicarboxylic acid, pyrazoledicarboxylic acid, pyrene 2,7-dicarboxylate, pyridine-2,3-dicarboxylic c acid, pyridine-3,4-dicarboxylic acid, pyridinedicarboxylic acid, quinoline-2,4-dicarboxylic acid, quinoline-3,4-dicarboxylic acid, quinoxaline-2,3-dicarboxylic acid, terephthalic acid, terphenyl dicarboxylate, tetradecanedicarboxylic acid, tetrahydrofurantetracarboxylic acid, tetrahydropyran-4,4-dicarboxylic acid, tetrahydropyrene 2,7-dicarboxylate, tetrazolates, thiophene-3,4-dicarboxylic acid, tricarboxylates, trioxaundecanedicarboxylic acid, 2,5-dioxido-1,4-benzenedicarboxylate, 4,6-dioxido-1,3-benzenedicarboxylate, or a combination comprising at least one of the foregoing linkers.

7. The storage system of claim 4, wherein the metal cluster comprises manganese, iron, cobalt, and nickel, and wherein the organic linker comprises at least one of 2,5-dioxido-1,4-benzenedicarboxylate or 4,6-dioxido-1,3-benzenedicarboxylate.

8. The storage system of claim 1, wherein the primary storage tank further comprises a pressure sensor operative to detect pressure of the boil-off gas within the primary storage tank; and wherein the secondary storage tank further comprises a pressure sensor operative to detect pressure of the desorbed boil-off gas within the secondary storage tank.

9. The storage system of claim 1, wherein the liquid comprises liquid hydrogen.

10. The storage system of claim 2, wherein the energy conversion system comprises a propulsion system, a fuel cell, a gas turbine, or an internal combustion engine.

11. A method of storing low latent heat of vaporization gases, the method comprising:
discharging a boil-off gas released from a primary storage tank to a secondary storage tank; wherein the primary storage tank is operative to store a liquid having a latent heat of vaporization of less than or equal to 1000 joules per gram; and wherein the secondary storage tank comprises a porous sorbent for reversibly storing the boil-off gas discharged from the primary storage tank.

12. The method of claim 11, further comprising discharging a desorbed boil-off gas from the secondary storage tank to an energy conversion system; wherein the energy conversion system comprises a propulsion system, a fuel cell, a gas turbine, or an internal combustion engine.

13. The method of claim 11, further comprising discharging the liquid from the primary storage tank directly to the energy conversion system.

14. The method of claim 11, wherein the boil-off gas is discharged to the secondary storage tank via a relief valve.

15. The method of claim 12, wherein the energy conversion system is operative to generate energy.

16. The method of claim 11, wherein the porous sorbent is selected from the group consisting of an activated carbon, an aluminophosphate, a conjugated microporous polymer, a covalent-organic framework, a crystalline open framework, a crystalline porous material, a hyper crossed-linked polymer, a metal organic framework, a metal-organic material, a microporous polymer network, an organic molecular solid, a polyaromatic framework, a polymer with intrinsic microporosity, a porous aromatic framework, a porous coordination network, a porous coordination polymer, a porous organic polymer, a porous polymer network, a silica particle, a silico-alumino-phosphate, a zeolite, a zeolitic imidazolate framework, a porous metal oxide, or a combination comprising at least one of the foregoing porous sorbents.

17. The method of claim 16, wherein the metal organic framework comprises a metal cluster and an organic linker.

18. The method of claim 17, wherein the metal cluster is selected from the group consisting of a transition metal, a post transition metal, an alkali metal, an alkaline earth metal, a lanthanide, a actinide, calcium, cadmium, cobalt, chromium, magnesium, manganese, iron, nickel, copper, ruthenium, zinc, zirconium, an ion thereof, a hydrate thereof, a salt thereof, a halide thereof, a fluoride thereof, a chloride thereof, a bromide thereof, an iodide thereof, a nitrate thereof, an acetate thereof, a sulfate thereof, a phosphate thereof, a carbonate thereof, an oxide thereof, a formate thereof, a carboxylate thereof, or a combination comprising at least one of the foregoing.

19. The method of claim 17, wherein the organic linker is selected from the group consisting of 1,3,5-benzenetribenzoate, 1,4-benzenedicarboxylic acid, 1,4-bis(carboxymethyl) piperazine-2,3-dicarboxylic acid, 1,4-bis-(phenylamino)benzene-2,5-dicarboxylic acid, 1,4-butanedicarboxylic acid, 1,4-cyclohexanedicarboxylic acid, 1,5-dioxide-2,6-naphthalenedicarboxylate, 1,6-hexanedicarboxylic acid, 1,7-heptanedicarboxylic acid, 1,8-heptadecanedicarboxylic acid, 1,8-naphthalenedicarboxylic acid, 1,9-heptadecanedicarboxylic acid, 2,2′-biquinoline-4,4′-dicarboxylic acid, 2,4-pyridinedicarboxylate, 2,5-dioxidobenzene-1,4-dicarboxylate, 2,5-pyridinedicarboxylic acid, 2,6 naphthalene dicarboxylate, 2,6-naphthalene dicarboxylic acid, 2-hydroxy-1,2,3-propanetricarboxylic acid, 2-isopropylimidazole-4,5-dicarboxylic acid, 2-methylimidazole-4,5-dicarboxylic acid, 2-methylquinoline-3,4-dicarboxylic acid, 2-nitrobenzene-1,4-dicarboxylic acid, 4,4′-diaminophenylmethane-3,3′-dicarboxylic acid, 4,4′-dihydroxyazobenzene-3,3′-dicarboxylic acid, 4,4′-dihydroxydiphenylmethane-3,3′-dicarboxylic acid, 4,4′-diaminodiphenyl-3,3′-dicarboxylic acid, 4,4′-dioxidobiphenyl-3,3′-dicarboxylate, 4,4′-dioxido-3,3′-biphenyldicarboxylate, 4,4′-dioxido-3,3′-triphenyldicarboxyl, 4,5-imidazoledicarboxylic acid, 4,6-dihydroxyisophthalic acid, 4-aminophenyl-1H-tetrazole, 4-cyclohexene-1,2-dicarboxylic acid, 4-oxopyran-2,6-dicarboxylic acid, 5,5-dioxodibenzothiophene-3,7-dicarboxylic acid, 5,6-dehydronorbomane-2.3-dicarboxylic acid, 5,6-dimethyl-2,3-pyrazinedicarboxylic acid, 5-ethyl-2,3-pyridinedicarboxylic acid, 5-hydroxy-1,3-benzenedicarboxylic acid, 5-t-butyl-1,3-benzenedicarboxylic acid, 6-chloroquinoxaline-2,3-dicarboxylic acid, 6-pyridinedi carboxy lie acid, 7,8-quinolinecarboxylic acid, 7-chloro-2,3,8-quinolinetricarboxylic acid, 7-chloro-3-methylquinoline-6,8-dicarboxylic acid, 7-chloro-4-hydroxyquinoline-2,8-dicarboxylic acid, 7-chloro-8-methylquinoline-2,3-dicarboxylic acid, 7-chloroquinoline-3,8-dicarboxylic acid, 8-tetracarboxy lie acid, 8-methoxy-2,3-naphthalenedicarboxylic acid, 8-nitro-2,3-naphthalenedicarboxylic acid, 8-sulfo-2,3-naphthalenedicarboxylic acid, acetylene dicarboxylate, acetylenedicarboxylic acid, adamantanedicarboxylic acid, adamantanetetracarboxylate, adamantanetribenzoate, anthracene-2,3-dicarboxylic acid, anthraquinone-1,5-dicarboxylic acid, aurinetricarboxylic acid, benzene dicarboxylate, benzenedicarboxylic acid, benzenetetracarboxylic acid, benzenetribenzoate, benzenetricarboxylate, benzenetricarboxylic acid, benzidine-3,3′-dicarboxylic acid, benzophenonetetracarboxylic acid, biphenyl dicarboxylate, biphenyl-4,4′-dicarboxylate, butanetetracarboxylic acid, butanetricarboxylic acid, cyclobutane-1,1-dicarboxylic acid, cyclobutyl dodecyl terephthalate, cyclohexene-2,3-dicarboxylic acid, cyclopentane-1,2,3,4-tetracarboxylic acid, cyclopentanetetracarboxylic acids, decanedicarboxylic acid, dicarboxylic acid, diimidedicarboxylic acid, dioxaoctanedicarboxylic acid, dioxybiphenyl-2,2′-dicarboxylate, diphenylether-4,4′-dicarboxylic acid, eicosenedicarboxylic acid, furan-2,5-dicarboxylic acid, heptadecanedicarboxylic acid, hexanetetracarboxylic acid, hexatriacontanedicarboxylic acid, imidazole-2,4-dicarboxylic acid, imidazole-4,5-dicarboxylic acid, 1-benzyl-1H-pyrrole-3,4-dicarboxylic acid, 1-methylpyrrole-3,4-dicarboxylic acid, naphtalenedicarboxylate, naphthalene-1,8-dicarboxylic acid, naphthalenedicarboxylic acid, o-hydroxybenzophenonedicarboxylic acid, octanedicarboxylic acid, octanetetracarboxylic acid, p-benzenedicarboxylic acid, pentane-3,3-carboxylic acid, perylene-3.4.9,10-tetracarboxylic acid, perylene-3,9-dicarboxylic acid, perylenedicarboxylic acid, perylene-1,12-sulfone-3,4,9,10-tetracarboxylic acid, perylenetetracarboxylic acids, phenylindanedicarboxylic acid, propanetricarboxylic acid, pyrazine-2,3-dicarboxylic acid, pyrazinedicarboxylic acid, pyrazole-3,4-dicarboxylic acid, pyrazoledicarboxylic acid, pyrene 2,7-dicarboxylate, pyridine-2,3-dicarboxylic acid, pyridine-2,6-dicarboxylic acid, pyridine-3,4-dicarboxylic acid, pyridinedicarboxylic acid, quinoline-2,4-dicarboxylic acid, quinoline-3,4-dicarboxylic acid, quinoxaline-2,3-dicarboxylic acid, terephthalic acid, terphenyl dicarboxylate, tetradecanedicarboxylic acid, tetrahydrofurantetracarboxylic acid, tetrahydropyran-4,4-dicarboxylic acid, tetrahydropyrene 2,7-dicarboxylate, tetrazolates, thiophene-3,4-dicarboxylic acid, tricarboxylates, trioxaundecanedicarboxylic acid, 2,5-dioxido-1,4-benzenedicarboxylate, 4,6-dioxido-1,3-benzenedicarboxylate, or a combination comprising at least one of the foregoing linkers.

20. The method of claim 17, wherein the metal cluster comprises manganese, iron, cobalt, and nickel, and the organic linker comprises at least one of 2,5-dioxido-1,4-benzenedicarboxylate or 4,6-dioxido-1,3-benzenedicarboxylate.
